(19) United States
(12) Patent Application Publication
(10) Pub. No.: US 2026/0196630 A1
(43) Pub. Date: Jul. 9, 2026

(54) BATTERY HOUSING COVER FOR A BATTERY HOUSING, PRESSING AND INJECTION MOLDING METHOD FOR MANUFACTURING A BATTERY HOUSING COVER AND BATTERY HOUSING

(71) Applicants: POLYTEC Composites NL B.V., Roosendaal (NL); AUDI AG, Ingolstadt (DE)

(72) Inventors: Julius RAUSCH, Heilbronn (DE); Walter VAN GILST, Roosendaal (NL)

(21) Appl. No.: 19/439,757

(22) Filed: Jan. 5, 2026

(30) Foreign Application Priority Data
Jan. 8, 2025 (DE) 10 2025 100 438.2

(51) Int. Cl. H01M 50/229; B60L 50/64; H01M 10/54; H01M 50/249; H01M 50/262

(52) U.S. Cl. CPC H01M 50/229; B60L 50/64; H01M 10/54; H01M 50/249; H01M 50/262; H01M 2220/20

(57) ABSTRACT

A battery housing cover for a battery housing for accommodating at least one traction battery with a frame structure formed from a thermoplastic plastic material having an outer frame, wherein the battery housing cover extends along an extension plane and at least one central region is bounded circumferentially in the extension plane by the outer frame, and wherein at least one sheet-like fiber-reinforced semi-finished product is arranged in the at least one central region so as to extend along the extension plane and is connected to the frame structure in a load-bearing and material-bonded manner.

### CROSS REFERENCE TO RELATED APPLICATIONS

The present application claims priority to German Patent Application 10 2025 100 438.2 filed Jan. 8, 2025.

According to a first aspect, the present invention relates to a battery housing cover for a battery housing for accommodating at least one traction battery, according to a second aspect to a battery housing for accommodating at least one traction battery and according to further aspects to a pressing method for producing a battery housing cover as well as to an injection molding method for producing a battery housing cover.

Battery housing covers and corresponding methods for manufacturing battery housing covers are already known from prior art.

Battery housing covers and battery housings made of metal materials are already known from prior art. The battery housings made entirely of metal or metal alloys have the significant disadvantage that the corresponding battery housings and/or battery housing covers each have a high dead weight due to the high density of the metal material. In an effort to reduce the resulting weight of the battery housing or battery housing covers, designs were chosen for the components in which different materials, such as metals and plastics, are combined to form the components. For example, battery housings have become known from prior art in which the housings are manufactured as a frame structure, wherein metallic profiles, such as inter alia extruded profiles, are joined together to form a circumferential frame and the frame is then assembled with plastic components to form a fluid-tight receiving space. The disadvantage of the aforementioned methods is firstly the high production costs, as both the elements forming the frame and the plastic elements must be formed separately in different production steps and it must also be ensured that fluid-tight connections are realized in the area of the connecting surfaces to form the required fluid-tight battery housing or battery housing cover. This is accompanied by corresponding permanent bonds between the metal materials and plastic materials, which in turn has the significant disadvantage that the subsequent recyclability is significantly reduced due to the material pairing or that the effort required to separate the materials by type is significantly increased.

Based on the aforementioned disadvantages of the prior art, it is an object of the present invention to provide a battery housing cover and/or a battery housing as well as corresponding manufacturing methods for achieving the aforementioned objects according to the invention, in which the manufacturing effort, in particular the manufacturing steps required, can be reduced compared to the prior art. Furthermore, according to the invention, the recyclability is to be improved by suitable material pairing and the recycling effort is to be reduced.

The object is achieved in accordance with a first aspect of the invention by a battery housing cover for a battery housing for accommodating at least one traction battery with a frame structure formed from a thermoplastic plastic material having an outer frame, wherein the battery housing cover extends along an extension plane and at least one central region is bounded circumferentially in the extension plane by the outer frame, and wherein at least one sheet-like fiber-reinforced semi-finished product is arranged in the at least one central region so as to extend along the extension plane and is connected to the frame structure in a load-bearing and material-bonded manner. The battery housing cover for a battery housing is used to accommodate at least one traction battery, in particular a high-voltage battery or a high-voltage battery cell assembly, for driving a battery-electric vehicle, such as in particular a battery-electric car. The battery housing cover extends essentially flat along the extension plane.

According to the invention, the battery housing cover extends along the extension plane in a substantially plate-like manner, in particular in the area of the flat fiber-reinforced semi-finished products. The battery housing cover has a wall thickness orthogonal to the extension plane; according to the invention, the wall thickness of the flat fiber-reinforced semi-finished products is preferably less than the wall thickness of the frame structure. The outer frame and/or the webs have a greater wall thickness than the flat fiber-reinforced semi-finished products. The wall thickness of the flat fiber-reinforced semi-finished product can be selected in the range from 1 to 1.5 mm and the wall thickness of the frame can be selected in the range from 2 to 2.5 mm.

The flat fiber-reinforced semi-finished product is preferably connected to the frame structure in a load-bearing and material-bonded manner all the way around and via an edge area. The load-bearing and material-bonded connection between the frame structure and the flat fiber-reinforced semi-finished product, which extends in the at least one central region, forms a fluid-tight battery housing cover, which can be assembled with further elements to form a fluid-tight battery housing.

According to the invention, it can be provided that the frame structure additionally comprises at least one web, wherein the at least one web is formed from a first end along an extension axis in the extension plane to an opposite second end, wherein the first and the second end are connected to the outer frame and/or to a further web in a load-bearing and material-bonded manner.

According to the invention, it is thus provided that the at least one web can preferably subdivide or divide the central region into a plurality of central regions. According to the invention, the outer frame preferably delimits at least one substantially rectangular central region in the extension plane, wherein the at least one substantially rectangular central region, in which at least one flat fiber-reinforced semi-finished product is arranged extending along the extension plane and is connected to the frame structure in a load-bearing and material-bonded manner. It is preferred, according to the invention that the central region can be divided into several central regions by the arrangement of at least one web. According to the invention, this makes it possible to arrange a flat, fiber-reinforced semi-finished product extending along the extension plane by arranging at least one web in each of the several central regions and to connect it to the frame structure or the at least one web in a load-bearing and material-bonded manner.

Particularly preferably, the at least one web in the frame structure is provided such that it is arranged in the extension plane along a longitudinal and/or along a transverse axis of a substantially rectangular central region, thus creating a symmetrical subdivision in the central region into a plurality of uniform central regions. This is particularly advantageous, as the plurality of central regions can then be provided in the same shape and with the same dimensions, and a fiber-reinforced semi-finished product with the same dimensions and shape can be arranged in each region.

According to the invention, it can be provided that the region of the frame structure, in particular of the outer frame or of the at least one web, is intended to rest locally flat on a counterpart of the battery box, so that, inter alia, the battery housing cover according to the invention can be connected in the aforementioned region to a battery box or other structures located underneath. It can be provided that the region of the frame structure, in particular of the outer frame and/or of the at least one web, protrudes at least transversely and/or orthogonally from the plane of the extension plane and thus protrudes in particular from the flat fiber-reinforced semi-finished product of the extension plane. The protruding region can be designed as a connecting flange or connecting surface for connecting the battery housing cover to further components of the battery housing. It is particularly preferred that at least one sealing element can be arranged in the region.

According to the invention, it can be provided that a recess is formed in the battery housing between the at least one web and the outer frame in the extension plane.

The at least one web and the outer frame together form a border or an inner frame, which surrounds the recess in the gradient plane or defines a circumferential border in the extension plane.

The inner frame or the border have the option of attaching a further component, whereby a circumferential seal can in turn be provided in the area of the inner frame or the surround, so that the battery housing cover according to the invention can be connected after installation with a further suitable closure part, which is adapted to the dimensions and shape of the border or the inner frame, to form a sealed unit or a fluid-tight battery housing cover. In addition to the provision of the circumferential seal, screw connections can preferably be provided in the area of the border or inner frame, wherein the recess or inner frame can be designed to be raised or cantilevered from the extension plane. This means that the border surrounding the recess with its sealing flange and the screw connection can be formed to be raised relative to the extension plane of the battery housing cover. The cantilevered border or the inner frame can preferably be reinforced with ribs between the extension plane of the battery housing cover and the upper edge of the sealing flange, in particular to support the sealing flange.

According to the invention, it can be provided that a flat fiber-reinforced semi-finished product is arranged between the at least one web and the outer frame and/or the at least one further web in the extension plane.

It can be provided that the at least one web divides the outer frame in the extension plane along a longitudinal and/or transverse axis of the outer frame with mirror symmetry to form a plurality of central regions with the same dimensions along the extension plane, with a flat fiber-reinforced semi-finished product being arranged in each of the central regions.

It can be provided that the flat fiber-reinforced semi-finished product is connected to the frame structure such that the flat fiber-reinforced semi-finished product and the frame structure overlap in an edge area along the extension plane.

It can be provided that an edge area of the flat fiber-reinforced semi-finished product is at least partially embedded in or enclosed by the plastic material forming the frame structure. Preferably, a single-or double-shear connection can be formed in this respect in the form of mutually overlapping areas of the flat fiber-reinforced semi-finished product and the frame structure. In the extension plane, connection surfaces or areas of the flat fiber-reinforced semi-finished product and the frame structure can be formed tapering in a wedge shape.

It may be provided that the frame structure has a ribbed structure, wherein the ribbed structure has ribs which protrude from the top and/or from the bottom of the extension plane transversely or orthogonally to the extension plane. The ribbed structure can be formed particularly preferably in an edge area of the frame structure, particularly preferably in an edge area in which fastening holes are provided for the passage of fastening elements of the battery housing cover. According to the invention, the ribbed structure can be designed in the edge area such that any fluids that occur, such as water, can run off to the side; to this end, it can be provided that the ribs are interrupted locally in order to prevent the formation of a trough, so that any liquids that occur, such as water, can run off to the side from the area of the ribbed structure.

It can be provided that in the area of the frame structure, in particular in the area of the outer frame or the inner frame, at least one sealing groove geometry is formed along the extension plane. The at least one sealing groove geometry is preferably formed in an edge region of the frame structure, via which the battery housing cover according to the invention is attached to other structures or vehicle structures forming the battery housing. It can be provided that the sealing groove geometry is preferably formed circumferentially along the extension plane in the frame structure. Particularly preferably, two sealing groove geometries can be provided, whereby the two sealing groove geometries can be formed parallel to each other at a distance along the extension plane.

According to a particularly preferred embodiment, it can be provided that ribs are provided in the extension plane opposite the sealing groove geometries, which stiffen the battery housing cover according to the invention in the region of the sealing groove geometries and in particular increase the bending stiffness of the battery housing cover in its extension plane locally in the region of the sealing groove geometries. In particular, it is preferable for ribs to be formed on the opposite side of the battery housing cover relative to the sealing groove geometries provided.

It can be provided that a sealing compound is positively inserted into at least one sealing groove geometry form. In particular, it can be provided that the sealing compound is applied to the frame structure in the area of the sealing groove geometry by means of an overmolding process or assembly injection molding and permanently bonded to the frame structure. It can be provided that the sealing compound is connected to the frame structure in a load-bearing and material-bonded manner, particularly in the area of the sealing groove geometry.

Furthermore, it can be provided that the flat fiber-reinforced semi-finished product has at least one electromagnetic shielding layer, which is arranged extending along the extension plane and is arranged on a lower or upper surface of the flat fiber-reinforced semi-finished product or is embedded in the flat fiber-reinforced semi-finished product, so that direct contact with the underlying support area of a metallic battery box is possible. In this respect, it can be provided according to the invention that an electrically contacting connection device is provided, with which the electromagnetic shielding layer of the battery housing cover according to the invention can be electrically connected to further structures or further shielding layers of a battery housing.

In a preferred embodiment, it can be provided that the at least one flat fiber-reinforced semi-finished product has at least three layers with the following layer structure: A first and a second outer layer are each formed from at least one layer of a continuous fiber-reinforced fiber composite material, and an electromagnetic shielding layer is arranged between the first and second outer layers. The electromagnetic shielding layer can in turn be formed from an electrically conductive material, and particularly preferably the shielding layer can be formed from a metal foam or a foam material with an electrically conductive metal coating.

The electromagnetic shielding layer can be formed from at least one layer of an electrically conductive material, the at least one layer preferably comprising a metal foil or a metallic grid structure or a plastic fabric with a metal coating or a plastic foil with a metal coating.

The flat fiber-reinforced semi-finished product can preferably be formed from a fiber-reinforced plastic material, particularly preferably from a fiber-reinforced thermoplastic material. According to a particularly preferred embodiment, the flat fiber-reinforced semi-finished product can be formed from a GMT material.

The flat, fiber-reinforced semi-finished product is preferably made from an organic sheet. The fiber-reinforced plastic material can preferably comprise UD tape and/or a nonwoven fabric with fiber reinforcement, the UD tape and/or the fiber reinforcement layer extending along the extension plane, it being particularly preferred that the reinforcing fibers can be formed to extend along the extension plane.

The thermoplastic plastic material that forms the flat fiber-reinforced semi-finished product can comprise a long fiber and/or continuous fiber reinforcement.

The flat fiber-reinforced semi-finished product can be profiled and/or beads can be embossed into the semi-finished product.

According to the invention, the frame structure comprising the inner and/or outer frame or the at least one web can preferably be formed by a compression molding or injection molding process.

The frame structure can preferably be made of a glass fiber reinforced thermoplastic. According to the invention, it can also be provided that the frame structure is formed from a glass mat-reinforced thermoplastic plastic material. The frame structure is preferably formed using a DLFT material.

A pairing or material combination between the fiber-reinforced thermoplastic material of the frame structure and the flat fiber-reinforced semi-finished product is particularly preferable. According to the invention, the frame structure and the flat fiber-reinforced semi-finished product can thus be manufactured from the same plastic and/or fiber materials. For example, the frame structure can be formed from a fiber-reinforced polypropylene and the flat fiber-reinforced semi-finished product can also be formed from a propylene-based semi-finished product.

According to the invention, it can be provided that in the region of the frame structure, such as in particular in the region of the outer frame and/or the web, a plurality of apertures or holes are formed for the passage of fastening means. Fasteners, such as threaded inserts, can also be embedded in the area of the frame structure.

According to a second aspect, the present invention relates to a battery housing for accommodating at least one traction battery, comprising a battery housing cover according to the first aspect of the invention and a battery housing shell, wherein the housing shell can be joined to the battery housing cover to form an accommodation space for the at least one traction battery.

According to the invention, the formed receiving space can be enclosed on all sides or open on at least one side, for example for closure by further elements.

The housing cover and the housing shell can be joined together using appropriate fasteners to form a receiving space that is at least partially and/or completely fluid-tightly sealed off from the surroundings.

According to a further aspect, the present invention relates to a battery housing for accommodating at least one traction battery, comprising two battery housing covers according to the first aspect of the invention and a battery housing frame, wherein the battery housing frame can be joined to the battery housing covers according to the invention to form an accommodation space for the at least one traction battery.

It can be provided that the battery housing cover can be joined to the battery housing shell and/or the battery housing cover can be joined to the battery housing frame via fastening elements, preferably via a plurality of screws or screw elements.

According to a fourth aspect of the present invention, a pressing method for manufacturing a battery housing cover according to the invention can preferably be provided with the features according to the first aspect of the present invention, wherein the method comprises the following steps:
a) providing a blank of thermoplastic plastic material to form the frame structure;
b) providing at least one blank of a thermoplastic flat fiber-reinforced semi-finished product;
c) heating the thermoplastic blanks prepared in steps a) and b) to a temperature above the respective glass transition temperatures, particularly preferably above the melting points of the thermoplastics;
d) transferring and assembling the heated blanks according to a deposit pattern for the battery housing cover into an open mold cavity of a molding press; and
e) closing the mold cavity and applying a pressing pressure using the forming press to form the battery housing cover inside the mold cavity.

Alternatively, according to a further aspect of the present invention, an injection molding process for producing a battery housing cover according to the invention, preferably having the features according to the first aspect, can be provided, comprising the steps of:
a) providing a thermoplastic plastic material to form the frame structure;
b) providing at least one blank of a thermoplastic flat fiber-reinforced semi-finished product;
c) heating the at least one blank of a thermoplastic sheet-like fiber-reinforced semi-finished product provided in step b) to a temperature above the respective glass transition temperature, preferably above the melting point of the thermoplastic;
d) transferring and depositing the at least one blank heated in step c) in accordance with a deposit pattern for the battery housing cover into an open mold cavity of an injection mold;
and
e) closing the mold cavity of the injection mold, heating the thermoplastic plastic material from step a) and injecting the melted plastic material to form the frame structure of the battery housing cover to obtain the battery housing cover inside the mold cavity.

The compression molding or extrusion process according to the invention has the advantage that during the compression molding process for forming the battery housing cover according to the invention in the area of the flat fiber-reinforced semi-finished product, compression only occurs in the direction orthogonal to the extension plane, whereas compression molding or extrusion only occurs in the area of the frame structure during the compression molding process. Since extrusion only occurs in the area of the frame structure, the pressing pressure required to form the battery housing cover according to the invention can be significantly reduced.

In the following, exemplary embodiments of battery housing covers according to the invention for a battery housing are explained with reference to the accompanying Figures.

### IN THE FIGURES

FIG. 1A shows a schematic plan view of a first exemplary embodiment of a battery housing cover according to the invention;

FIG. 1B shows a sectional view of the battery housing cover as shown in FIG. 1A;

FIG. 2A shows a schematic plan view of a second exemplary embodiment of a battery housing cover according to the invention;

FIG. 2B shows a sectional view of the battery housing cover as shown in FIG. 2A;

FIG. 3A shows a schematic plan view of a third exemplary embodiment of a battery housing cover according to the invention;

FIG. 3B shows a sectional view of the battery housing cover as shown in FIG. 3A; and

FIGS. 4A-4E show five different embodiments of the connection and transition area between the frame structure and the flat fiber-reinforced semi-finished product in an enlarged sectional view.

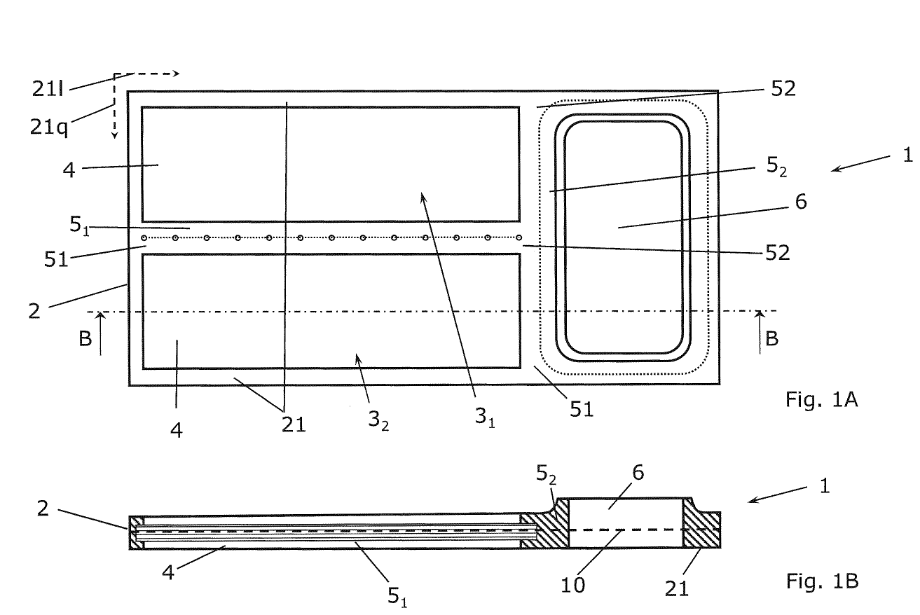

FIG. 1A shows a schematic plan view of a battery housing cover 1 according to the invention in a first exemplary embodiment. The battery housing cover 1 for a battery housing for accommodating at least one traction battery first has a frame structure 2 formed from a thermoplastic material with an outer frame 21, wherein the battery housing cover 1, as illustrated by the dashed line in FIG. 1B, extends along an extension plane 10 and at least one central region 3 in the extension plane 10 is bounded circumferentially by the outer frame 21. In the exemplary embodiment shown in FIGS. 1A and 1B, the battery housing cover 1 comprises two central regions, which are identified by the reference numerals 3₁ and 3₂. FIG. 1A thus shows a plan view of the extension plane 10 of the battery housing cover 1. According to the invention, unlike in mathematics, the extension plane 10 is intended to have a thickness in order to also form a certain height of the frame structure orthogonal to the extension plane, as can be seen in FIG. 1B. In the at least one central region 3, at least one flat fiber-reinforced semi-finished product 4 is arranged so as to extend along the extension plane 10 and is connected to the frame structure 2 in a load-bearing and material-bonded manner. In the exemplary embodiment shown, a flat fiber-reinforced semi-finished product 4 is arranged in each of the two central regions 3₁ and 3₂. In the embodiment shown, the two central regions 3₁ and 3₂. are formed by two webs 5, the respective web extending from a first end 51 along an extension axis 50 in the extension plane 10 to an opposite second end 52, the first and second ends 51, 52 each being connected to the outer frame 21 and/or to a further web 5 in a load-bearing and material-bonded manner. The embodiment shown in FIG. 1 has two webs 5, a first web 5₁ dividing the outer frame 21 in the extension plane 10 along a longitudinal direction 21l with mirror symmetry, the second end 52 of the first web, which extends along the longitudinal axis, being connected to a further second web 5 with a material bond. The second web 5₂ extends along a transverse direction 21q of the outer frame 21 and is connected to the outer frame 21 at the first end 51 and the second end 52 in a load-bearing and material-bonded manner, with a recess 6 being formed in the battery housing cover between the second web 5₂ and the outer frame 21 in the extension plane 10. As can be seen from FIG. 1A, the outer frame 21 is divided by the first web 5₂ in the extension plane 21 along the longitudinal direction 21l in mirror symmetry to form the two central regions 3₁ and 3₂, which have the same dimensions along the extension plane 10. As can be seen in particular in the sectional view of FIG. 1B, it can be provided that the flat fiber-reinforced semi-finished product 4 is connected to the frame structure 2 such that the flat fiber-reinforced semi-finished product 4 and the frame structure 2 overlap in an edge area along the extension plane 10. As shown as an example in FIG. 1B, the flat fiber-reinforced semi-finished product 4 is completely embedded in the frame structure 2 in the edge area and enclosed by it.

As exemplified in FIG. 1A, a plurality of apertures or holes can be provided in the area of the frame structure 2, in particular in the area of the web 5, through which, for example, fastening means for fastening or screwing the battery housing cover can be provided.

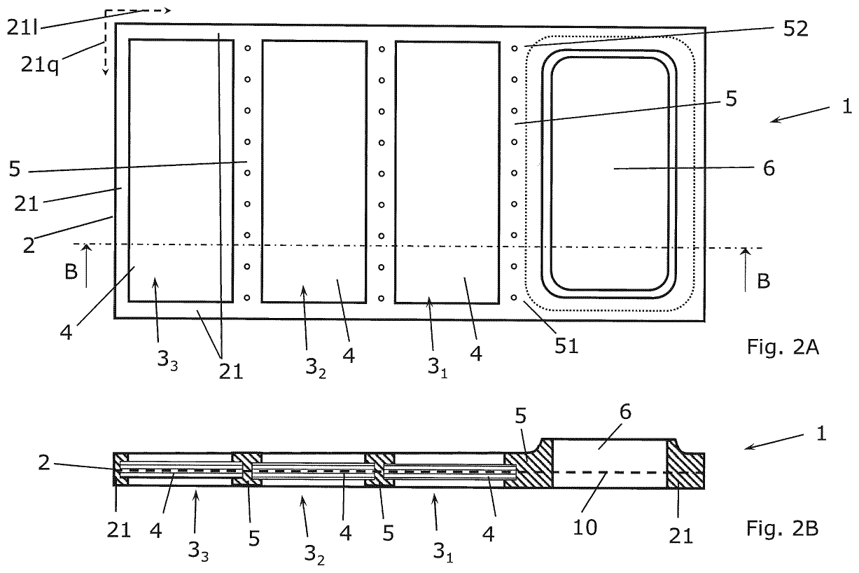

FIGS. 2A and 2B show a second exemplary embodiment of a battery housing cover according to the invention, wherein the embodiment according to FIGS. 2A and 2B differs from FIGS. 1A and 1B in that according to FIGS. 2A and 2B the central region is subdivided by the provision of three webs 5, wherein the webs 5 each extend along a transverse direction 21q relative to the outer frame 21 and subdivide the outer frame 21 into three central regions 3₁, 3₂ and 3₃. Furthermore, a recess 6 is formed in the battery housing cover 1 between the transverse web 5 on the right in the plane of the drawing and the outer frame 21. As can also be seen in particular from the section according to FIG. 2B, the three central regions 3₁, 3₂ and 3₃ are each formed with a flat fiber-reinforced semi-finished product 4, which is arranged extending along the extension plane 10 and is connected to the frame structure 2 in a load-bearing and material-bonded manner. In the embodiment shown in FIGS. 2A and 2B, openings or holes are provided in the areas of the crossbars 5 for screwing or fastening the battery housing cover 1 to other structures.

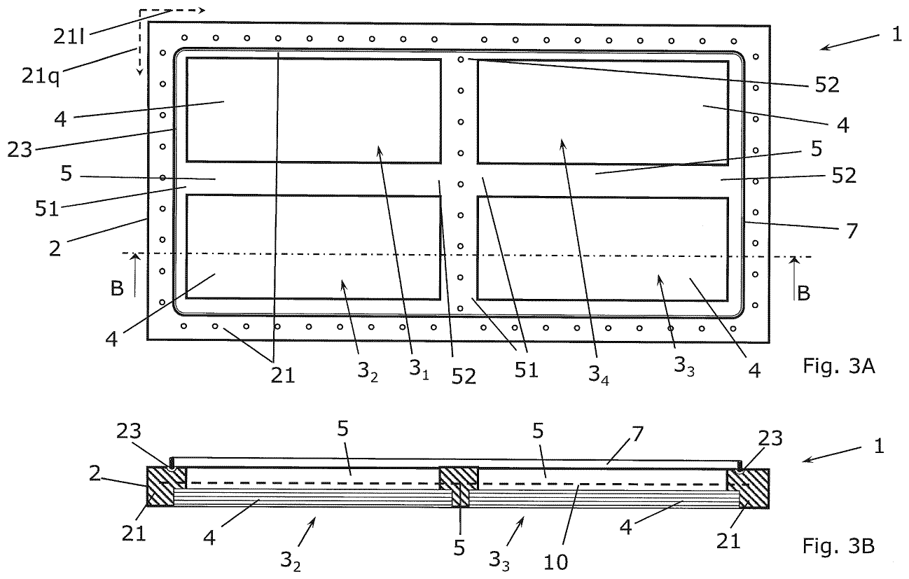

FIGS. 3A and 3B show a further exemplary third embodiment of a battery housing cover according to the invention, wherein, according to FIGS. 3A and 3B, the central region is divided into four central regions 3₁, 3₂, 3₃ and 3₄ by two longitudinal and two transverse webs 5. In the embodiment shown in FIGS. 3A and 3B, fastening holes are again provided both in the area of the outer frame 21 and in the area of the two crossbars 5. Furthermore, the exemplary embodiment of the battery housing cover 1 shown in FIGS. 3A and 3B has a sealing groove geometry 23, in which a sealing compound 7 is positively inserted.

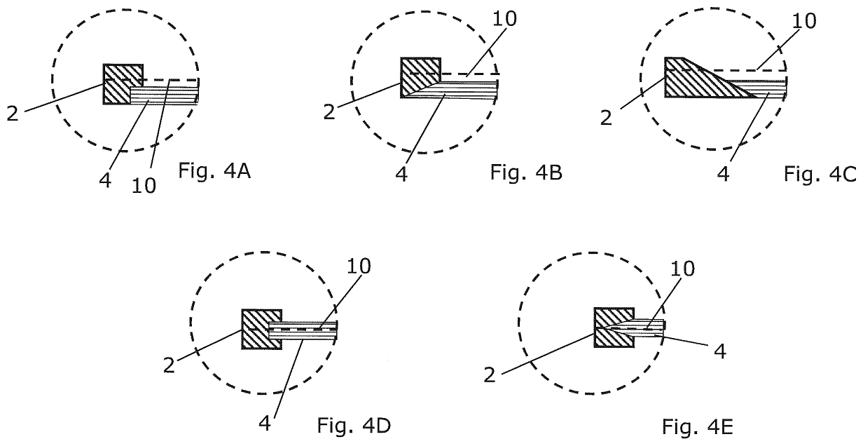

FIGS. 4A to 4E show five different connection configurations in an edge area of a flat fiber-reinforced semi-finished product 4 and the frame structure 2. FIGS. 4A to 4C show single-shear connections, while FIGS. 4D and 4E show double-and two-shear connections respectively. Preferably, it can be provided that the flat fiber-reinforced semi-finished product 4 and/or the frame structure 2 is designed to taper in a wedge shape along the extension plane 10.

What is claimed is:

1. A battery housing cover for a battery housing configured to accommodate at least one traction battery, comprising: a frame structure formed from a thermoplastic plastic material and having an outer frame; wherein the battery housing cover extends along an extension plane and at least one central region in the extension plane is bounded circumferentially by the outer frame; and wherein, in the at least one central region, at least one flat fiber-reinforced semi-finished product is arranged to extend along the extension plane and is connected to the frame structure in a load-bearing and material-bonded manner.

2. The battery housing cover of claim 1, wherein the frame structure additionally comprises at least one web, wherein the at least one web extends from a first end along an extension axis in the extension plane to an opposite second end, wherein the first end and the second end are connected to at least one of the outer frame or a further web in a load-bearing and material-bonded manner.

3. The battery housing cover of claim 2, wherein a recess is formed in the battery housing cover between the at least one web and the outer frame in the extension plane.

4. The battery housing cover of claim 2, wherein a flat fiber-reinforced semi-finished product is arranged between the at least one web and at least one of the outer frame or at least one further web in the extension plane.

5. The battery housing cover of claim 2, wherein the at least one web divides the outer frame in the extension plane along at least one of a longitudinal axis or a transverse axis of the outer frame in mirror symmetry to form a plurality of central regions with the same dimensions along the extension plane, wherein a flat fiber-reinforced semi-finished product is arranged in each of the central regions.

6. The battery housing cover of claim 1, wherein the flat fiber-reinforced semi-finished product is connected to the frame structure such that the flat fiber-reinforced semi-finished product and the frame structure overlap in an edge area along the extension plane.

7. The battery housing cover of claim 1, wherein the frame structure comprises a ribbed structure, wherein the ribbed structure comprises ribs projecting from at least one of an upper side or a lower side of the extension plane transversely to the extension plane.

8. The battery housing cover of claim 1, wherein the frame structure has at least one sealing groove geometry along the extension plane.

9. The battery housing cover of claim 8, wherein a sealing compound is introduced into the at least one sealing groove geometry in a form-fitting manner.

10. The battery housing cover of claim 1, wherein the flat fiber-reinforced semi-finished product has at least one electromagnetic shielding layer which is arranged extending along the extension plane on a lower or upper surface of the flat fiber-reinforced semi-finished product or is embedded in the flat fiber-reinforced semi-finished product, wherein an electrical contacting to a support region of a metallic battery box is formed via an electrical contact element.

11. The battery housing cover of claim 10, wherein the electromagnetic shielding layer comprises at least one layer of an electrically conductive material, the at least one layer comprising at least one of: a metal foil; a metallic grid structure; a plastic fabric with a metal coating; or a plastic foil with a metal coating.

12. The battery housing cover of claim 1, wherein the flat fiber-reinforced semi-finished product is formed from a fiber-reinforced plastic material.

13. The battery housing cover of claim 1, wherein the frame structure is formed via a pressing process or an injection molding process.

14. The battery housing cover of claim 1, wherein the frame structure is formed from a glass fiber-reinforced thermoplastic plastic material.

15. A battery housing for accommodating at least one traction battery, comprising a battery housing cover of claim 1 and a housing shell, wherein the housing shell is joinable together with the battery housing cover to form a receiving space for the at least one traction battery.

16. A battery housing for accommodating at least one traction battery, comprising two battery housing covers each of claim 1 and a housing frame, wherein the housing frame is joinable together with the battery housing covers to form a receiving space for the at least one traction battery.

17. The battery housing of claim 15, wherein the housing cover is joinable to the housing shell or to the housing frame via fastening elements comprising a plurality of screws.

18. A pressing method for producing a battery housing cover, the method comprising the steps of: (a) providing a blank of thermoplastic plastic material to form the frame structure; (b) providing at least one blank of a thermoplastic flat fiber-reinforced semi-finished product; (c) heating the thermoplastic blanks prepared in steps (a) and (b) to a temperature above the respective glass transition temperatures; (d) transferring and assembling the heated blanks according to a deposit pattern for the battery housing cover into an open mold cavity of a molding press; and (e) closing the mold cavity and applying a pressing pressure using the molding press to form the battery housing cover inside the mold cavity.

19. An injection molding method for producing a battery housing cover, the method comprising the steps of: (a) providing a thermoplastic plastic material to form the frame structure; (b) providing at least one blank of a thermoplastic flat fiber-reinforced semi-finished product; (c) heating the at least one blank provided in step (b) to a temperature above the respective glass transition temperature; (d) transferring and depositing the at least one blank heated in step (c) in accordance with a deposit pattern for the battery housing cover into an open mold cavity of an injection mold; and (e) closing the mold cavity of the injection mold and injecting melted plastic material to form the frame structure of the battery housing cover to obtain the battery housing cover inside the mold cavity.
